(19) United States
(12) Patent Application Publication
(10) Pub. No.: US 2012/0210310 A1
(43) Pub. Date: Aug. 16, 2012

(54) SYSTEMS AND METHODS FOR COORDINATING THE UPDATING OF APPLICATIONS ON A COMPUTING DEVICE

(75) Inventors: James W. Cooley, Seattle, WA (US); Neal E. Tucker, Seattle, WA (US)

(73) Assignee: ZenZui, Inc., Seattle, WA (US)

(21) Appl. No.: 11/690,591

(22) Filed: Mar. 23, 2007

(51) Int. Cl. G06F 9/44

(52) U.S. Cl. 717/168

(57) ABSTRACT

The present invention is directed to systems and methods which schedule the updating of applications and/or application data to occur according to a priority dependant upon a variety of dynamically changing factors. In one embodiment, a service manager schedules the update from the network server to occur when the device on which the updating application resides is not otherwise busy with functions that would cause a burden on network usage or with the user's current experience with the device or with battery life. The new data is transferred from the network server to the wireless device, upgrading on an irregular schedule based on at least some factors individual to the particular applications. In the embodiment shown, after the service manager has determined that new data has been transferred to the device for a particular application, then that application is prompted to begin the data upgrade process only at a time when the impact on the user and on the battery level of the device is only minimally affected.

### CROSS-REFERENCE TO RELATED APPLICATIONS

This patent application is related to concurrently filed, co-pending, and commonly-assigned: U.S. patent application Ser. No. ______, Attorney Docket No. 72514/P001US/10703616, entitled “SYSTEMS AND METHODS FOR CONTROLLING APPLICATION UPDATES ACROSS A WIRELESS INTERFACE”; U.S. patent application Ser. No. ______, Attorney Docket No. 72514/P003US/10703619, entitled “SYSTEMS AND METHODS FOR CONTROLLING GROUP MESSAGING”; the disclosures of which are incorporated herein by reference.

### TECHNICAL FIELD

This disclosure relates to updating applications and more particularly to systems and methods for efficiently updating applications that reside on a computing device.

### BACKGROUND OF THE INVENTION

It is now common to use mobile devices to obtain information on a continuous basis. Such data could be, for example, the latest weather, sports scores, or the data could pertain to airline flight information or any other type of information that is presented to, or accessed by the user of the device from time to time. This presentation of the information to the user is controlled by an application (service) that then needs to be updated on some basis, either periodically, or on demand, or when bandwidth is available. The updating of the application can be simply that the data (i.e. the actual weather or sports information) needs to be refreshed or often it happens that the application itself needs to be updated to accommodate new features, to repair errors, etc.

The problem then becomes how and when to perform the update so that it is both timely available and does not degrade the present use of the device nor tax the device battery while also using as little processing time as possible. For example, battery life is impacted when radio transmission occurs in order to download the data from a network server. Thus, the time when the new data crosses the air interface is an issue.

Another aspect of the problem is that sometimes the update data is available while the user is using the existing application. In such situations, updating the application, or updating the data used by the application is impractical since doing so at that particular time will interfere with the user's current activity.

### BRIEF SUMMARY OF THE INVENTION

The present invention is directed to systems and methods which schedule the updating of applications and/or application data to occur according to a priority dependant upon a variety of dynamically changing factors. In one embodiment, a service manager schedules the update from the network server to occur when the device on which the updating application resides is not otherwise busy with functions that would cause a burden on network usage or with the user's current experience with the device or with battery life. The new data is transferred from the network server to the wireless device, upgrading on an irregular schedule based on at least some factors individual to the particular applications. In the embodiment shown, after the service manager has determined that new data has been transferred to the device for a particular application, then that application is prompted to begin the data upgrade process only at a time when the impact on the user and on the battery level of the device is only minimally affected.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a mobile device utilizing the concepts of the invention;

FIG. 2 shows one embodiment of a flow diagram of the operation of the actual data upgrade as it occurs on the wireless device; and

FIGS. 3 and 4 show embodiments of methods for controlling the operation of the application update function of the device shown in FIGS. 1 and 2.

### DETAILED DESCRIPTION OF THE INVENTION

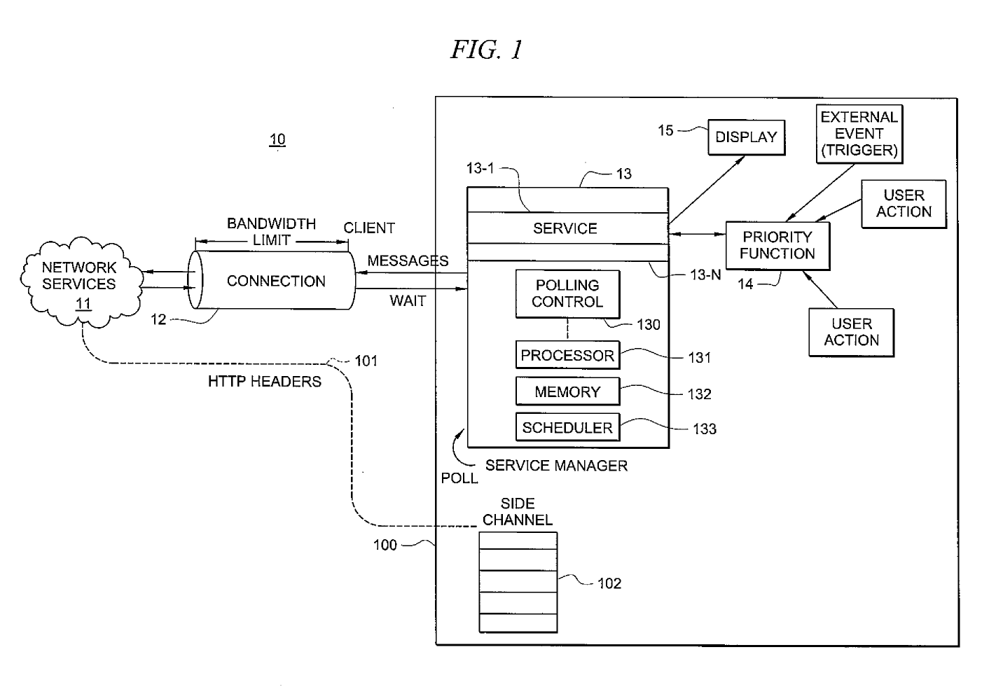

FIG. 1 shows one embodiment 10 of a mobile device 100 (only a portion of which is illustrated) utilizing the concepts of the invention. Connection 12 exists between device 100 and network server 11. Connection 12 has a bandwidth limitation, either imposed by the physical network or imposed by the user such that the user is only willing to pay for a certain amount of data transmission (often measured in bytes per unit time). Sometimes the cost per byte is less expensive at certain times (such as at night) so the user prefers to use “night” bytes instead of “day” bytes when possible.

Device 10 contains service manager 13 which in turn controls various services (or data types) 13-1 to 13-N. Each of the services 13-1 to 13-N has associated therewith a priority function 14. The purpose of each service 13-1 through 13-N is to perform a particular function (application) that ultimately results in data displayed to the user via display 15. Each service 13-1 through 13-N requires some time (bandwidth) on the wireless interface and service manager 13 balancing each bandwidth request against all other service bandwidth requests against a number of factors. The priority of each service is incorporated into the priority function for each service. Since the overall connection has a bandwidth limit, the availability of the connection to any particular service is balanced across all services according to an individual priority function associated with each service. Since the priority function for a given service can change from time to time, the use of the connection is dynamically balanced and thus adapts to user load patterns in accordance with each user's needs and desires. This adaptation can use a variety of functions, such as, for example, Baysian or support vector machine and can support adaptive or designed balancing or combinations thereof.

For example, assume a user desires to use only one megabyte per day. That megabyte is rationed out in some order during the day according to a plan for that user. The plan can, for example, be based on statistics, for example, B-spline or linear, for that user, or on anyone of many other techniques, such as, for example, probability of usage of target application or data, neural network, location-based function, GPS. The air transport time can be rationed at so many megabytes per hour, if desired. The service manager then will only allow the connection to be used up to the threshold limit. To accomplish this, the service manager periodically pulls through the list of services that require bandwidth and processes the highest priority service first until it reaches the bandwidth limit set for the connection. The service manager then waits until the next pulling interval and repeats the process. The priority functions themselves are constantly changing their priority levels and thus at each polling opportunity the highest priority functions are served first.

For example, assume that a user desires to have a weather application, a news application and a sports application. The weather application may have a high priority assigned to it during the hours of 6 AM to say 9 AM. Thus, during these hours the weather information is updated every, say ten minutes. Likewise, the news application has a high priority in the morning but then switches so that only “breaking” news stories are reported during the day. The sports application has a priority such that scores are reported only at 6 AM and then again only at 10 PM, except that when a favorite team (or teams) are actually playing, then the priority changes to every five minutes.

Another example would be when the user performs an action, such as pressing a key or changing the view on the display. This action then could immediately change the priority function of the associated application (service). This then would allow the service manager to control updates on a more immediate basis.

During the time the service manager is managing the connection, there can be a side channel of HTTP headers, such as headers 101. These side channel headers piggyback on other messages. For instance, if service A is communicating with server 11, service B can also communicate with the server at the same time on the same message using a side channel message such as message 102.

The purpose of the side channel is to process certain class of service requests that are small but frequent or potentially frequent, but where it is not necessary to establish an explicit transaction on the network. Thus, when one service makes a request and gets a response, several other services can have their small but important requests multiplexed on the established requests so that they effectively share that time slice. An example would be for an application to check for the presence of an update such that if an update exists, then time can be scheduled to actually update the application. It is the side channel that the service manager uses to determine when an update is available so that the service manager can then schedule that update to be transmitted across the air interface at the most efficient time.

Note that while FIG. 1 shows a single manager and only one connection, in actuality there can be many connections, each with a service manager. In one embodiment, each connection is to a separate URL and thus there is a one to one relationship between the service manager and a connection. In this embodiment, all services which connect to the same host (URL) are associated with the same single service manager and with the same connection. In this manner, when processing service requests, the system can connect to the same host and port and thus the connection can be opened only once for all the applications that communicate with the same server. This reduces the overhead of the communication by leaving it open for multiple services. In turn, this reduces battery usage because the device radio is used less.

Another example of dynamic function changing is when messages are being sent back and forth to another mobile device. The user then wants the message sending and receiving service to have a high priority during this exchange but then also wants that priority to taper off over time as the conversation dies so that the device does not use up a lot of network bandwidth checking for messages. The priority function could be anything that is reset by user actions. Examples of priority changes are: periodic, constant, decreasing priority, increasing priority.

Another example would be using statistics about times when network access has been accomplished or when things are available. This would work well for applications that change over time, such as a traffic map. The priority function would track the changes in traffic patterns during, for example, rush hours and could therefore dynamically increase and decrease its priority assigned to updating the information from the server.

The priority could be tailored to usage. For instance, a user may regularly begin his/her day by looking at the traffic information, then checking the news and then looking at the weather icon on the display. These items can be clustered to update as a group. Using this arrangement, the system might be a little late on traffic, but will be ahead on the other services in that group. For a flight icon (tile), for instance, one of things that affects the priority might be the proximity in time to the flight. As the time comes closer the priority can go higher for updating departure and gate information. The system might update once a day when the flight is a couple of days away and then start updating at, say, 15 minute intervals, when it is within a few hours of flight time.

Also the system might have a flight tile that contains several airlines on it. When the tile is selected, the system could determine which airline has the highest priority from the several possible airlines on the tile with the priority based on calendar information available to the system. Thus, if the user is booked on an American Airlines flight, then the user probably does not need an update of Continental flights at that point in time.

Thus, by having access to other information, the priority of the information into the phone can be managed consistent with reducing bandwidth and battery drain and to give the user increased value from the device. Thus, when it is snowing outside, the phone could sound an alarm earlier than normal to alert the user to longer commute times based on the knowledge of the weather and the user's calendar of scheduled activities.

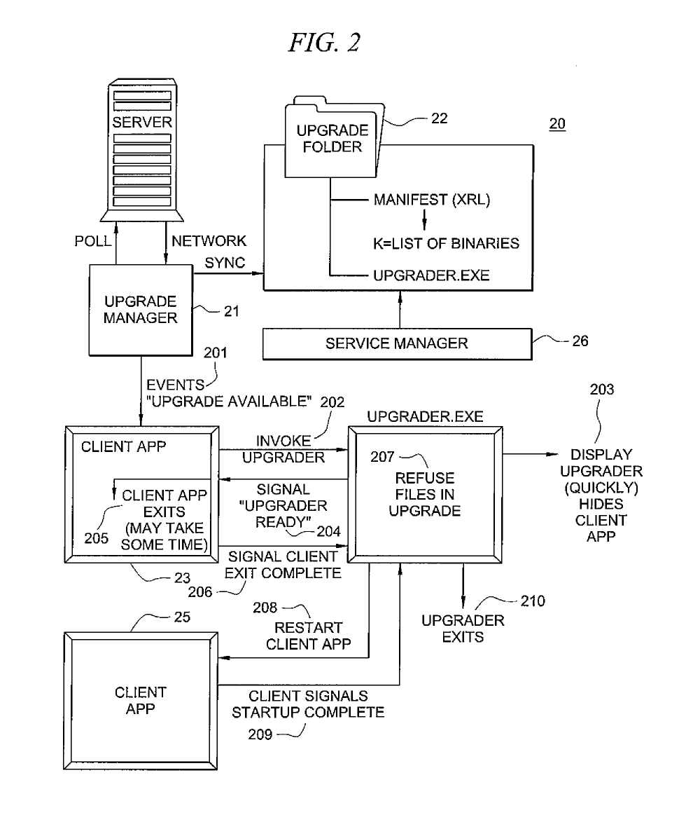

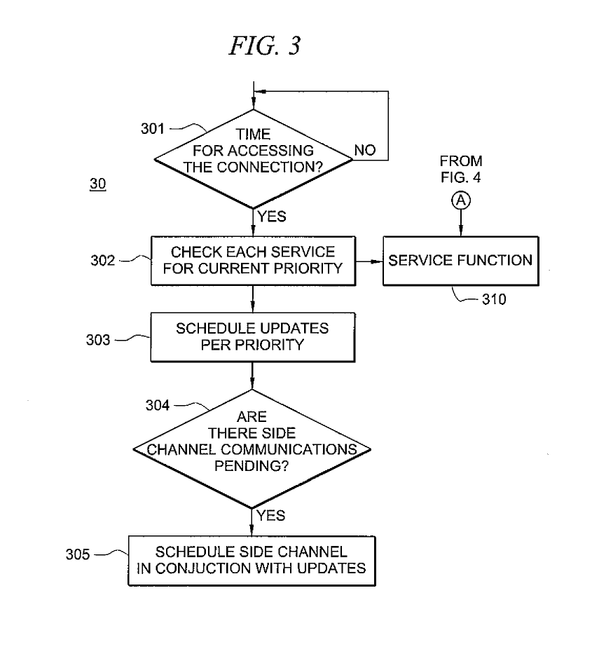

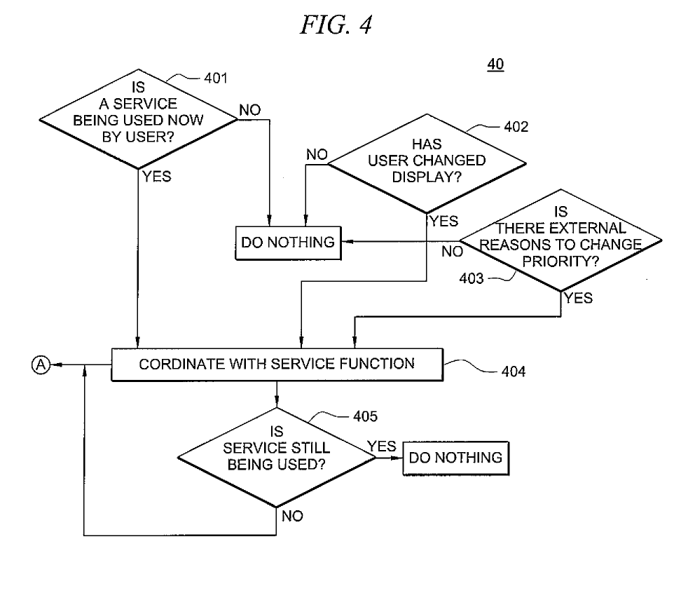

FIG. 2 shows one embodiment of a flow diagram, such as flow diagram 20, of the operation of the actual upgrading of an application, or the updating of data used by an application, as it occurs on the computing device. As discussed above with respect to FIG. 1, and as will be discussed below with respect to FIGS. 3 and 4, the updated data (whether it be a version change in an application, or simply a data update) is brought across the wireless interface at an appropriate time under control of service manager 26 and placed in an upgrade folder, such as folder 22, all under control of upgrade manager 21. This operation is discussed in above-identified co-pending application entitled SYSTEMS AND METHODS FOR CONTROLLING APPLICATION UPDATES ACROSS A WIRELESS INTERFACE.

Manager 21 signals (201) to the application that an upgrade is available. Manager 21 can, if desired, operate based on the adaptive techniques as discussed above, for example. linear, B-spline, Bayesian, probability of usage of target application, neural network, location-based function, GPS. The application then invokes (202) a stub application which provides feedback (203) to the user that an update is about to occur. This feedback includes hiding the application from view by the user so that during the upgrade process the user cannot have access to the application. This hiding can be, for example, removing (or dimming) the application icon from the device display. The stub application moves the upgrade into position to be used by the application and signals ready (204) to the application. If desired, the upgrader can display progress to the user such as time remaining, etc. Some applications can take a relatively long time to close down (quit running) (205) and thus even though the updated data file is small, the total upgrade time can be relatively long. During this period of time, some applications must write out their internal state and save the files so as to free up memory, etc. which functions can take some time. When the application is completely closed, then it is unloaded from memory and the upgrader application receives (206) an event signal indicating that the application has exited.

At this point, the upgrader application is still in control of the upgrade progress, including the display, and begins copying files. Again, if desired, update progress can be given to the user. The files are then upgraded with the new data (207) and when the files are completely updated, the upgrader signals (208) the application to restart. When the restart is complete, the application signals (209) that fact to the upgrader which then exits (210), allowing the application icon to again become active for activation when desired by the device user. In one embodiment, the operations in the device are controlled by machine executable code running under control of, for example, processor 131.

FIGS. 3 and 4 show embodiments of methods for controlling the operation of the application update function of the device shown in FIG. 1. In FIG. 3, embodiment 30 begins with process 301 determining if it is time for accessing a particular network server for those applications which reply on that server for updated information. This time is determined by a combination of calculations based on current battery level, time of day, current activity of the user with respect to the device, how long it has been since the last access to the server, how much data has already been transmitted in a given unit of time, etc. When it is time to make an access, then process 302 checks each service to determine relative priority of that application and then based on the relative priority and the available bandwidth for that connection, as determined by process 301, working in conjunction with process 310, one or more applications are updated by process 303.

Process 304 determines whether there are side channel communications that need to occur, and if so, process 305 schedules those communications.

Processes 401, 402 and 403 of embodiment 40, as shown in FIG. 4, are examples of processes that determine if a priority is to be changed at a particular time. Thus, process 401 determines if a service is being used by the user, process 402 determines if the user has changed the display (for example, by selecting a tile, or a particular service within a tile); and process 403 determines if there is some external reason to change priority. Such an external reason could be, for example, a breaking news story, a sports event going into overtime, weather conditions turning hazardous, etc.

Process 404 then coordinates this information with process 310, as shown in FIG. 3, so as to change the priority of the service. Process 405 determines when a user has stopped using a service. For example, instant messaging is finished and thus the priority for that service can return to its normal priority level. Note that the examples discussed above are only a few of the many factors that can change priority on a dynamic basis and in many situations multiple factors are used to determine relative priority and timing for a network server access, all coordinated to conserve bandwidth and battery life for the user.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of upgrading one of a plurality of applications resident on a device, said method comprising:
storing on said device upgrading data for a target ones of said of applications to be upgraded, said data stored separate from said target applications;
determining, without user interaction, an appropriate time to perform said upgrade on each said application;
performing an upgrade on a particular target application on said device at said determined time for said target application, said upgrade using said stored upgrading data for said target application; and
making said target application unavailable to a user of said device while said upgrade is being performed, while still allowing other applications to be available for use.

2. The method of claim 1 wherein said appropriate time is determined on a priority basis among said applications.

3. The method of claim 1 wherein said determining is based, at least in part, on one or more functions selected from the list of: device activity, battery usage, linear, B-spline, Bayesian, probability of usage of target application, neural network, location-based function, GPS

4. The method of claim 1 wherein applications are activated by a user by selecting a tile containing an icon of said application and wherein said making comprises:
deactivating said icon on a display of said device.

5. The method of claim 4 further comprising:
reactivating said deactivated icon on said display when said upgrade is complete.

6. The method of claim 5 wherein said device is a cellular telephone.

7. The method of claim 1 further comprising:
downloading said upgrading data from a location remote from said device to said device wirelessly at a time calculated by said device to conserve battery life.

8. A wireless device comprising:
a display for allowing a device user to visually interact with a selected one of a plurality of applications currently active on said device;
memory for storing data pertaining to a desired change in a version of a particular one of said applications stored on said device; and
a transition manager for determining based on parameters pertaining to said particular application when it is time to enable a transition from an existing version of said particular application to said desired changed version of said particular application; said determination made so as to minimize the impact on a device user during said transition.

9. The device of claim 8 wherein said manager is further operable for preventing said user from visually interacting with said particular application during said transition.

10. The device of claim 8 wherein said interaction is enabled by selection of an icon on said display.

11. The device of claim 8 wherein said manager is further operable for controlling said transition from said existing version to said desired version.

12. The device of claim 8 further comprising:
a service manager for controlling a download of said desired change data from a location remote from said device to said storage, said download occurring independent from said transition.

13. The device of claim 8 wherein said time determining is made without input from said user.

14. The device of claim 8 wherein said transition manager is operative for determining when it is time to enable transitions from a plurality of existing versions of different applications to a desired changed version of each of said plurality of different applications; and
a scheduler for prioritizing enabling said transitions as among said plurality of applications.

15. Machine controllable code stored on a computing device, said code operable for:
allowing a user of said device to visually interact with one of a plurality of applications currently active on said device;
controlling storage on said device of data pertaining to a desired change in a version of a particular one of said applications stored on said device; and
determining based on parameters of said particular application when it is time to enable a transition from an existing version of said particular application to said desired changed version of said particular application; said determination made so as to minimize the impact on a device user during said transition.

16. The code of claim 15 further operable for preventing said user from visually interacting with said particular application during said transition.

17. The code of claim 16 further operable for:
controlling a download of said desired change data from a location remote from said device to said device, said download occurring independent from said transition.

18. The code of claim 16 wherein said time determining is made without input from said user.

19. The code of claim 18 wherein said time determination is made based, at least in part, on one or more functions selected from the list of: device activity, battery usage, linear, B-spline, Bayesian, probability of usage of target application, neural network, location-based function, GPS.

20. The code of claim 16 further operable when said transition is completed for:
restarting said application; and
re-enabling said user visual interaction with said application.

21. The device of claim 14 wherein said prioritizing is based on application type.

22. The device of claim 14 wherein said prioritizing is based on proximity to a time when application data is projected to be important to a user.

23. The device of claim 14 wherein said prioritizing is based, at least in part, on parameters external to said device.

24. The device of claim 14 wherein said prioritizing is based on current battery level.

25. The device of claim 14 wherein said prioritizing is based, at least in part, on available bandwidth of a connection associated with delivery of said data.

26. The device of claim 11 wherein while said transaction is occurring at least one other of said applications can be active on said device.

27. A method of updating data pertaining to one of a plurality of applications resident on a device, said method comprising:
determining, without user interaction, an appropriate time to perform updating of application data for a particular application, said determining prioritizing among a plurality of applications as to an order among said applications for said updating; and
performing at said prioritized time said updating of said applications using application updating data from a location remote from said device.

28. The method of claim 27 further comprising:
making a currently updating one of said application unavailable to a user of said device while still allowing said device user to interact with other ones of said applications.

29. The method of claim 27 wherein said prioritizing is responsive to parameters external to both said device and said remote location.
